(19) United States
(12) Patent Application Publication
(10) Pub. No.: US 2016/0209612 A1
(43) Pub. Date: Jul. 21, 2016

(54) COMMUNICATIONS CABLE AND METHOD OF MAKING SAME

(71) Applicant: Technology Mining Company, LLC, Addison, TX (US)

(72) Inventor: Calvin H. Woosnam, Coquitlam (CA)

(21) Appl. No.: 13/943,330

(22) Filed: Jul. 16, 2013

Related U.S. Application Data
(63) Continuation of application No. 12/246,445, filed on Oct. 6, 2008, now abandoned.
Application No. 12/246,445 is a continuation-in-part of application No. 12/021,076, filed on Jan. 28, 2008, now abandoned.
(60) Provisional application No. 60/886,905, filed on Jan. 26, 2007.

(51) Int. Cl. G02B 6/44; H04B 10/29; H04B 10/40; H04B 10/2575; H04B 10/11

(52) U.S. Cl. CPC G02B 6/4432; G02B 6/4436; H04B 10/2575; H04B 10/11; H04B 10/40; H04B 10/29

(57) ABSTRACT

A communications cable and method for making same wherein a communications cable is able to withstand significantly higher thermal temperatures than conventional fiber whether it be general purpose, or rated as Plenum/Riser rating, or even MIL Spec type cables. A core fiber glass material with at least an 800 Fahrenheit degree operating ability allows the communications cable to survive in high heat or stress conditions. A polyimide coating on the outside of the fiber is a high temperature material and lends to this high operating temperature capability. By containing and protecting an optical pair of these fibers or even up to 4 glass fibers within a silicone rubber 1 mm diameter buffer tube, thermal protection of the high temperature glass within is increased. A single buffer tube type product and market that as a mini solution for fiber optic requirements within equipment or we individually or group wise mechanically protect these buffer tubes. The choice and decision to apply 2 layers of opposing woven aramid/KEVLAR™ fibers now begins to apply a enhance tensile strength capability resulting in significant increase of currently available fiber optic cables. Once this mechanical protection layer has been applied a second, but thicker layer of silicone rubber is applied as an outer protection jacket either over the single paired Duplex Cable or the 24 Pair or larger cable design.

### CROSS-REFERENCES TO RELATED APPLICATIONS

This application is a continuation of U.S. patent application Ser. No. 12/246,445, filed Oct. 6, 2008, which is a continuation-in-part of U.S. patent application Ser. No. 12/021,076, filed Jan. 28, 2008 and claims the benefit for priority from U.S. Provisional Application No. 60/886,905 filed Jan. 26, 2007, all of which are incorporated herein by reference in their entireties.

### BACKGROUND OF THE INVENTION

Fiber Optic cables typically exist in two major categories, those being Single Mode and Multi-Mode. Single mode is typically used for longer uninterrupted cable runs such as metropolitan outside networks and long distance wide area networks, where Multi-Mode is used for shorter distances such as within buildings. Multi-Mode Fiber Optic cables typically create much more threat of damage due to structural fires and the requirement to sustain significantly higher temperatures.

Fiber Optic cables using Multi-Mode fiber typically have distance limitations due to the optical carrying characteristics which degenerate optical signals to an unusable state either by attenuation or scrambling resulting in unusable signal after 3000 feet.

Fiber Optic cables used inside buildings, such as the type described above when used in commercial buildings generally carry a Plenum or Riser rating, meaning they must be able withstand temperatures of at least 90 Centigrade (200 Fahrenheit) degrees. As such, their outer jacket material is required to not sustain or permit a migration of any fire when subjected to a flame either in a vertical Riser condition or in a horizontal air Plenum configuration. Cables without this flame retardant additive typically can cause fire migration and are generally illegal by local and National building codes.

Fiber Optic cables defined as Plenum or Riser Standards qualified by any respective Standards Organization, such as (UL) Underwriters Laboratories (USA) or (CSA) Canadian Standards Association or other standards organization as registered or recognized in many countries typically use fire retardant material added to a PVC (poly vinyl chloride) or Teflon type TEP (Thermally Enhanced Plastic). PVC type plastics typically bum or melt at temperatures of approximately 400 degrees Fahrenheit. Teflon type jackets typically start to burn or melt at 600 degrees Fahrenheit.

Fiber Optic cables typically use a wrap or semi woven single layer of multiple strands of aramid or KEVLAR™ type fibers. This weaving or wrapping over a 1/16^{th} inch diameter core buffer tube holding the optical fibers acts as a strain relief system providing 100+ foot pounds of strain relief in the longitudinal direction, taking the load off the fragile fibers contained within the buffer tube. This strain relief mechanism allows for pulling of the optical cables through a conduit system without the fear of damaging the optical fibers from excessive longitudinal strain being applied to them.

Typically, duplex Multi-Mode fiber cables use a 1/16^{th} inch diameter buffer tube to contain the glass optical fibers within, and this tube is typically made of TEFLON™ or a similar clear plastic. The diameter of this tube is minimal, yet sufficient to contain the duplex color keyed fibers and may contain up to 4 discrete fibers.

Typical duplex Multi-Mode or Single Mode fiber cables use a color jacket over the 50 μm and 62.5 μm. or 9 μm respectively diameter fibers. This color jacket, in turn, is covered with a clear coat polyimide coating that is similarly rated to 200° F. or 90° C. maximum active operating temperature. This base glass diameter is then coated, bringing the overall diameter of each strand of optical glass to 125 μm overall diameter regardless of whether the core glass fiber is 50 μm or 62.5 μm diameter. This results in 12.5/2 μm=6.25 μm additional reinforcement over the glass for 50 μm Multi Mode Fiber. In comparison, the reduced overall diameter of Single mode fiber is only 9 μm in diameter and therefore significantly more susceptible to physical damage.

### SUMMARY

In one embodiment, the present communications cable and method for making same provides a high temperature duplex optical fiber system that is designed to operate over a much higher temperature range than current 90° C. or 200° F. Plenum/Riser rated cables. An embodiment incorporated within the present communications cable and method for making same provides a duplex 50 μm×125 μm Multi-Mode fiber optic cable that is able to withstand more mechanical forces at higher temperatures than conventional 62.5 μm fiber and significantly more than Single Mode 9 μm fibers. Fabrication of this fiber optic cable in stages permits a core buffer tube design to facilitate a simple buffer tube only product minimizing space when strength is not required.

In another embodiment, the present communications cable and method for making same provides for a simple Duplex fiber jacketed cable with KEVLAR™/aramid dual bias weave, and alternatively provides a individually buffer tubed 24 pair or higher multi channel cable all with the same base buffer tube component with KEVLAR™/aramid overall reinforcing.

In the preferred embodiment of the present communications cable and method for making same, the resilience to higher temperatures and the higher mechanical damage resilience are afforded by design of a Multi-Mode fiber optic system. This typically limited length distribution system is greatly overcome by the later joining of fiber sections of up to 3000 feet in length through a media converter, thereby permitting unlimited or infinite lengths to be achieved.

In another embodiment of the present communications cable and method for making same, individual fibers comprising high temperature silicon based glass that withstand smaller diameter radius bends without significantly diminishing optical transmission capability. The resilience to bend radius reduction is on a magnitude of 5 to 10 times more turns then the normal number of small diameter bends previously achieved by the same amount of loss in any other fiber, this, once again significantly increases the efficiency of a cable and may even challenge any historical feet length limits, generally 3000 feet, for Multi Mode cables.

The various embodiments described herein for the present communications cable and method for making same were derived from Applicant's experience with the repeated historical failure of conventional commercial cable known as Plenum or Riser rated cables. This antique classification for heat ratings of cables has been shown to repeatedly be ineffectual in building communications systems when fires threaten any area, thereby cutting off any communications path offered by these type cables. This historically makes fiber optic cable much more prone to failure then their copper counterparts. Communications saves lives and any time that those communications can be maintained during a threatening event like a fire, the more likely the loss of life will be reduced. Applicant realized that a solution begins with the glass used in these cables and notoriously this type of high temperature glass and its associated high cost makes the normal solution almost unaffordable or unattainable. Applicant therefore has created a new and unique blend of silicon glass and outer silicone rubber jacketing and reduced the basic product diameter to a preferable 50 μm inner diameter glass fiber. This new high temperature glass combined with smaller diameter, yet thicker outer coatings, while still equaling the qualifying diameter for Multi-Mode fiber of preferably 125 μm offers added tensile and side impact resistance to mechanical damage for these types of fibers.

These two fibers, or paired optical fibers, are then preferably contained within a heat resistant silicone 1.5 mm diameter tube with 250 μm thick walls. This preferable configuration then becomes a buffer tube only “Mini Multi Mode Fiber” design for use in small confined spaces subject to higher temperatures where mechanical protection is not required.

In another embodiment for the present communications cable and method for making same, instead of using a single layer of crisscrossed woven aramid or KEVLAR™ type fibers, dual layers in opposing direction were chosen to enhance the longitudinal force or tensile strength of the protected optical fiber pair and silicone rubber buffer tube. In this embodiment, these dual opposing layers of aramid/KEVLAR™ material can either be singly applied to single silicone rubber buffer tube as in a Duplex design or can be clustered around multiple silicone rubber buffer tubes as in the 24 pair, but not limited to, as described in the designs herein. In such case of the 24 pair design, a further inclusion of a Aramid/KEVLAR™ bundled core at the core of the cable significantly adds to the longitudinal force handling capability of this multi pair cable design.

In a preferred embodiment of the present communications cable and method for making same, the final thermal and mechanical protection layer is the unique application of silicone rubber on the outer jacket of a cable. This outer jacket is approximately 1 mm thick with an overall outer diameter of 3.2 mm. A jacket is formed and applied in such a way as to provide a tight fit over the aramid/KEVLAR™ fibers thereby eliminating any air pockets from forming which might promote combustibles or air circulation in high heat situations.

Embodiments disclosed herein overcome limitations and costs of current optical fiber cables while providing a significant increase in resistance to thermal damage typically associated with fiber optical fibers. In addition, embodiments of the present invention present new unobvious cable jacketing, longitudinal strength members, increased temperature handling capacity of the buffer tube component and improved high temperature optical glass.

Applicant provides a use of silicone rubber material as a substitute for various standards of plastics, thermally enhanced plastics and TEFLON™, that significantly increases the thermal survivability of a communications cable. In addition, Applicant provides a use of an enhanced silica/silicone blend that significantly increases resistance to thermal damage at high temperatures.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration showing a cross-section of a communications cable according to an embodiment of the present invention;

FIG. 2 is an illustration showing a cross-section of a communications cable according to another embodiment of the present invention;

FIG. 3 is an illustration showing a cross-section of a communications cable according to yet another embodiment of the present invention;

FIG. 4 is a side view of a multi-fiber splice tray for an embodiment of the present invention.

### DETAILED DESCRIPTION OF THE PREFERRED EMBODIMENT

In the preferred embodiment of the present communications cable and method for making same, a high temperature optical glass is provided that is capable of withstanding temperatures in excess of the 800 degree Fahrenheit range. Preferably, 2-50 μm×125 μm Multi-Mode fibers are both color coated and mechanically protect with a similarly high temperature polyimide plastic bring the overall diameter to 125 μm and leaving Buffer colors of Natural, and Blue for easy polarity identification. In the Quad design grouping additional Yellow and Red colors are used for further easy identification.

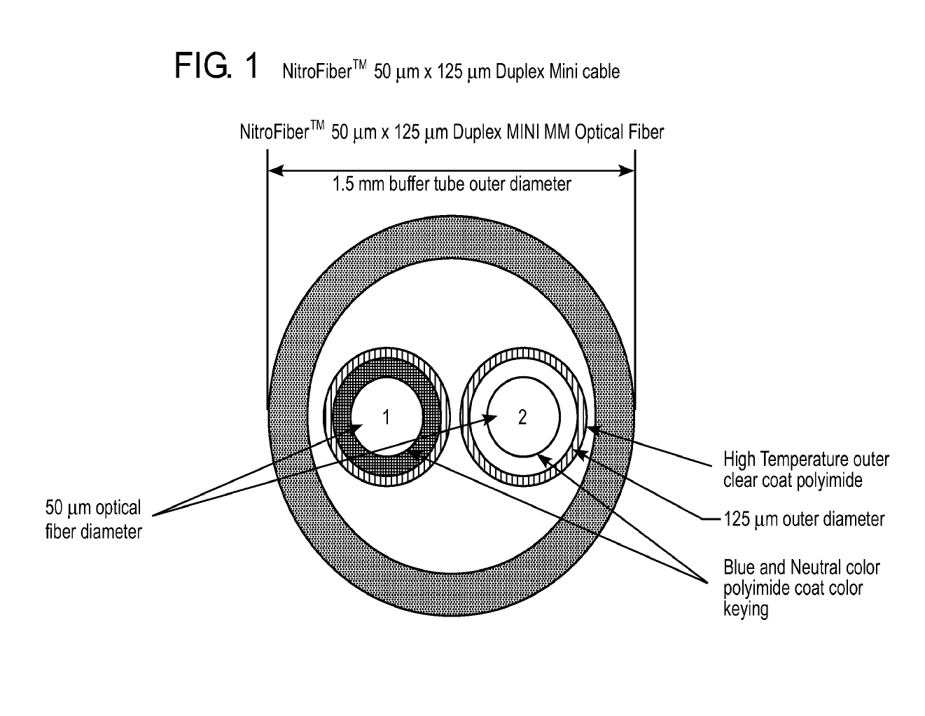

As shown in FIGS. 1-3, in a first step, preferably two and up to four optical fibers are placed within a high temperature protective silicone rubber buffer tube, to enhance their thermal handling properties. As shown in FIG. 1, this silicone rubber buffer tube is preferably approximately 1 millimeter in outside diameter.

In FIG. 1, the nature of the product at this stage with its thermal and mechanical enhancement can now be used in a separate product definition referred to as a Mini MM Duplex or Quad optical fiber design, suitable for use inside equipment where temperatures maybe elevated but mechanical damage is significantly reduced.

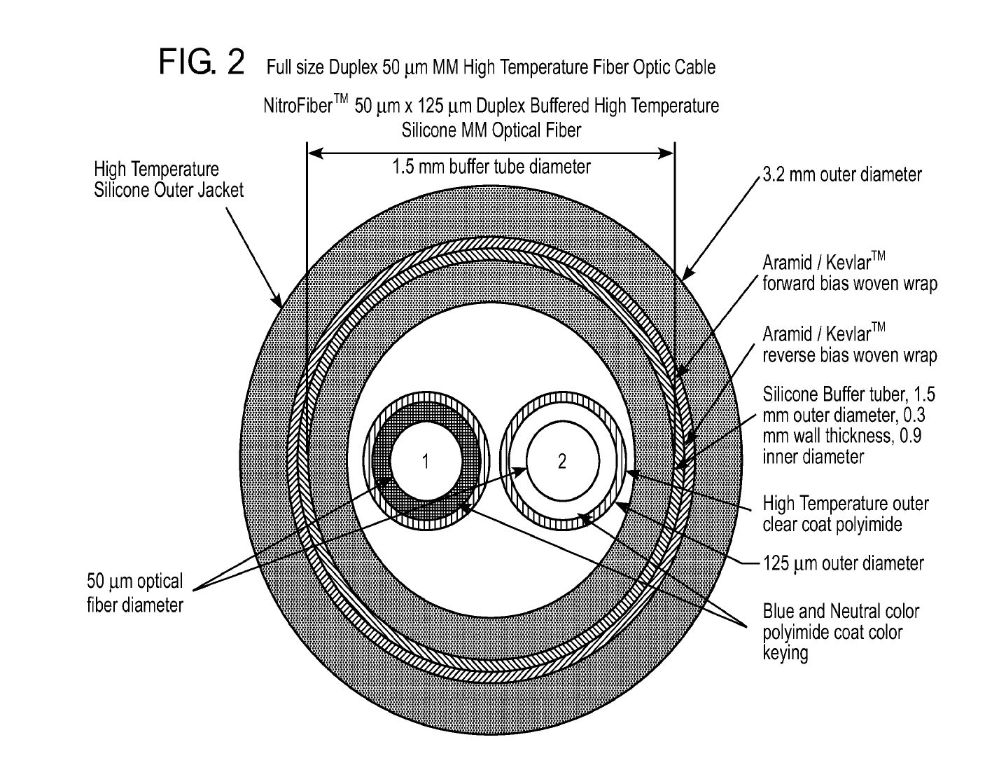

In a second step, a dual layer opposing directions woven aramid or KEVLAR™ type material is applied, providing enhanced tensile strength warding off forces that might otherwise damage the delicate glass fibers within. The individual multi strand nature of these woven strands adds significant longitudinal force handling capability. If only a single buffer tube is grouped then this is destined to be a Duplex or Quad Cable design, as shown in FIG. 2.

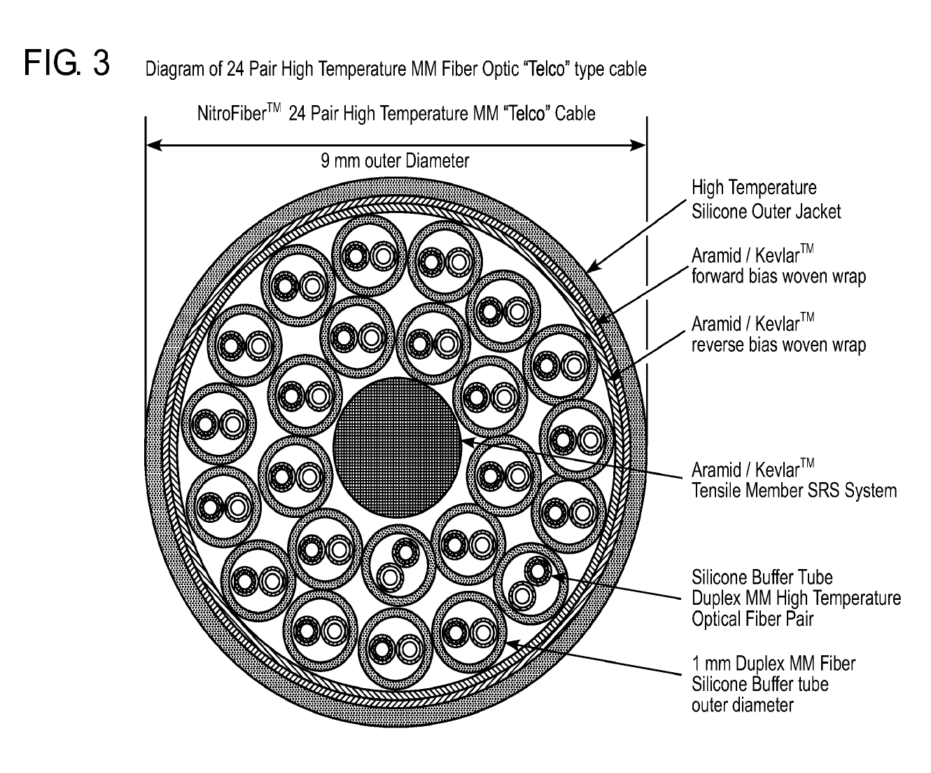

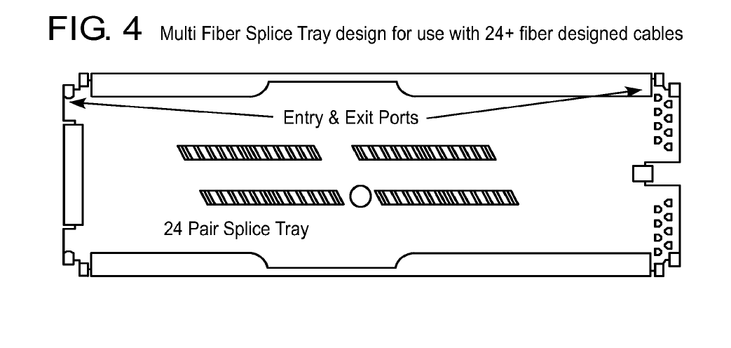

If the single duplex Mini buffer tube is required to be grouped into multiple channels within the same overall cable design, then the aramid/KEVLAR™ dual opposing woven layers can be placed over the entire group of buffered duplex fiber optic lines, as shown in FIG. 3. A reason for this individual grouping of Duplex lines within a single outer protective casing is to facilitate easy connectorizing of individual pairs. Similarly, if multiple channels are needed to be spliced or coupled then common race type splice tray may be used for thermal binding, as shown in FIG. 4.

As shown in FIGS. 2-3, in a third step, an outer protective jacket as described herein, is applied over the aramid/KEVLAR™ protective tensile strength members, which provides yet another heavier jacket of high temperature heat resistant silicone rubber.

In the preferred embodiment, the nominal maximum tensile load of the cable with the dual layers of aramid/KEVLAR™ woven yam is rated at 450 N during installation and with an actual in service rating of 200 N, supporting long suspended applications.

As shown in FIG. 3, in another embodiment, an additional 3.5 mm aramid/KEVLAR™ cord is placed within the center of the multi-paired cable, offering substantially more tensile strength capability for even greater load bearing ability. This central reinforcing cord can be secured at each cable end thereby transferring any longitudinal stress applied to the cable from affecting the delicate glass fibers within.

The aramid/KEVLAR™ material used within the strain relief system (SRS) is also of a higher than normal heat resistant nature, future insuring that no single component within the present communications cable and method for making same will lessen the survivability of the entire cable.

In an embodiment of the present communications cable and method for making same, fully assembled communications cable shown in FIG. 2 is approximately 3 mm in nominal diameter. In an embodiment shown in FIG. 3, the overall diameter similarly of a fully assembled communications cable is 9 mm. More or less pairs within a multi-pair cable will alter proportionately the diameter of the cable.

In the embodiment shown in FIG. 1, the Multi Pair Telco type cable will not change in overall diameter should the pairing within each Duplex buffer tube be increased to 4 optical fibers from the existing 2 optical fibers.

The minimum bend radius of the communications cables shown in FIGS. 1-3 are rated as 15× the nominal diameter of the either cable packaging during installation or loading, and 10× the nominal diameter of the either cable while in service.

The high temperature optical glass and refractive coatings configuration of the packaging will preferably exhibit a standard loss ratio around a reduced 4 mm core at 100 turns of no more than 1.5 dB.

The operating temperature of the finished product in the embodiments shown in FIGS. 1-3, may be −65° C. (−85° F.) to +250° C. (+482° F.) while the storage non operating temperature may be −40° C. (−40° F.) to +70° C. (+158° F.).

The non physical stressed high temperature rating of the fiber remains in operation as long as there is no applied motion to the optical cable once the heat has been applied up to an including a temperature of 1200 degrees Fahrenheit.

The optical nature of the glass and associated refractive coatings will preferably provide no more than 1.5 dB/km at a nominal operating frequency of 1300 nm.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed is:

1. A communications system providing a fault-tolerant communications path for narrow and broad band communication comprising:
one or more self-powered satellite units each providing signal information to at least one command console through a segmented cable assembly system, wherein the segmented cable assembly system comprises a multi-mode fiber optic cable;
a central station that receives signal information from the at least one command console and relays signal information back to the command console wirelessly and via the segmented cable assembly system.

2. The communication system of claim 1, wherein the segmented cable assembly system is powered by a controller outfitted with a transceiver and an external high gain antenna.

3. The communication system of claim 1, wherein the segmented cable assembly system includes a repeater.

4. The communications system of claim 1, wherein the segmented cable assembly system includes a UWB radio and antenna.

5. The communication system of claim 1, wherein the segmented cable assembly system comprises between two and four optical fibers within a high temperature silicone rubber buffer tube.

6. The communication system of claim 5, wherein the silicone rubber buffer tube is approximately 1 mm in outside diameter.

7. The communication system of claim 1, wherein the segmented cable assembly system comprises dual layer opposing directions woven aramid or KEVLAR type material surrounding optical fibers.

8. The communication system of claim 1, wherein the segmented cable assembly system is grouped into multiple channels and dual layer opposing directions woven aramid or KEVLAR type material surrounds groups of optical fibers.

9. The communication system of claim 1, wherein the segmented cable assembly system comprises an outer protective jacket over the optical fibers.

10. The communication system of claim 1, wherein the segmented cable assembly system comprises between two and four optical fibers within a high temperature silicone rubber buffer tube, dual layer opposing directions woven aramid or KEVLAR type material surrounding the silicone rubber buffered tube, and an outer protective jacket over the woven aramid or KEVLAR type material.

11. The communication system of claim 1, wherein the nominal maximum tensile load of cables within the segmented cable assembly system is 450 N during installation and 200 N in service.

12. The communication system of claim 1, wherein the segmented cable assembly system comprises an aramid or KEVLAR cord within the center of a multi-paired cable.

13. The communication system of claim 12, wherein the cord is approximately 3.5 mm in diameter.

14. The communication system of claim 1, wherein the segmented cable assembly system comprises a cable that is approximately 3 mm in nominal diameter.

15. The communication system of claim 1, wherein the segmented cable assembly system has a minimum bend radium 15 times the nominal diameter of cable during installation or 10 times the nominal diameter of cable while in service.
